(19) United States
(12) Patent Application Publication
(10) Pub. No.: US 2023/0150833 A1
(43) Pub. Date: May 18, 2023

(54) METHOD FOR PRODUCING A NICKEL ZINC COBALT SPINEL FERRITE IN CERAMIC FORM

(71) Applicant: Université Brest Bretagne Occidentale, Brest (FR)

(72) Inventors: Jean-Luc MATTEI, Locmaria-Plouzane (FR); David SOURIOU, Garons (FR)

(73) Assignee: Université Brest Bretagne Occidentale, Brest (FR)

(21) Appl. No.: 17/915,371

(22) PCT Filed: Mar. 30, 2021
(86) PCT No.: PCT/EP2021/058371

§ 371 Date: Sep. 28, 2022

(30) Foreign Application Priority Data
Mar. 31, 2020 (FR) FR2003212

(51) Int. Cl. C01G 51/00

(52) U.S. Cl. CPC C01G 51/40; C01P 2002/32; C01P 2002/50

(57) ABSTRACT

A method of obtaining a nickel zinc cobalt spinet ferrite in ceramic form that includes the following: obtaining a precipitate (1) of iron, nickel, zinc, and cobalt hydroxides by co-precipitation, rinsing the precipitate (2), drying and grinding (3) the rinsed precipitate in order to obtain a powder; forming (4) into a compact by pressing the powder, and sintering (5) the compact. The sintering (5) includes a progressive temperature rise of 2° C. to 4° C. per minute, from an ambient temperature to reach a maximum temperature comprised between 950° C. and 1.010° C., maintaining at the maximum temperature for forty-five minutes to three hours, a progressive fall in temperature of 2° C. to 4° C. per minute to reach ambient temperature. The foregoing and, in particular, the sintering, enable a material to be obtained that is particularly well-adapted to the manufacture of an antenna configured for frequencies less than one gigahertz.

The invention relates to the field of magneto-electric materials, in particular spinel ferrites and their obtainment method.

In particular, the invention relates to a method of obtaining a material of spinel ferrite type in ceramic form, particularly suitable to be employed for forming an antenna, for example in particular a V/UHF antenna (V/UHF standing for “Very/Ultra High Frequency”) with the object of reducing the size thereof. V/UHF antennas are commonly employed for communications in the aeronautical sector.

The present invention thus in particular relates to the miniaturization of airborne V/UHF antennas, for example in particular for the 118 MHz-174 MHz frequency band. Such antennas may equip aircraft, and the invention is thus in particular directed to reducing the number, the weight, and the size of antennas carried by an aircraft. It may also be applied to creating antennas of reduced size that are particularly adapted for the internet of things.

Among the numerous technologies making it possible to reduce the size of antennas, the most widespread technology uses the dielectric properties of materials. Such a solution proves relatively effective depending on the type of antenna but it generally gives rise to limitations as to antenna performance. Dielectric materials of high permittivity enable a significant reduction in the size of radiating structures such as microstrip type antennas. However, this leads to a large drop in their bandwidth and in the radiating efficiency provided by the antenna.

It has recently been shown, at least theoretically, that the use of a magneto-dielectric material (that is to say one having both a magnetic susceptibility and a dielectric permittivity that are not zero) was more advantageous since it limits the losses of bandwidth and increases the radiating efficiency, while enabling a significant reduction in the size of an antenna employing such a material.

Earlier instances of work on the subject are known, suggesting that the use of a magneto-dielectric material was capable of improving the bandwidth of the antennas by a factor of three relative to antennas based on other technologies, for small antennas. Nevertheless, the poor availability of suitable materials in acceptable conditions, both in terms of cost and ease of obtainment at a sufficient scale, appear to be one of the problems that has delayed the development of this work and the achievement of concrete results, and to this day it remains a substantial problem.

As a matter of fact, these materials are not naturally available with the properties desired at the frequencies of interest (for example for the aforementioned frequency band of 118 MHz to 174 MHz) including in particular a high permeability, low losses, and a low conductivity.

In particular, spinel ferrites in the form of dense ceramics, having a porosity less than 2%, are commonly used at frequencies less than 300 MHz due to their high permeability, and their low electrical conductivity. Such spinel ferrites make use of the oxides of Ni—Zn, Mg, Li, as well as their derivatives. However, spinet ferrites in such a dense form are not suitable for all applications, in particular for airborne communication antennas, due to the high magnetic losses which are linked to the phenomenon of spin resonance, the existence of which is linked to the size of the grains constituting the ceramic.

Certain properties of a first magneto-dielectric material of spinet ferrite type have been disclosed recently in the scientific paper “Miniaturisation d'une antenne monopole large bande utilisant des matériaux magnéto-diélectriques en bande VHF” (a translation of which is “Miniaturization of a broadband monopole antenna using magneto-dielectric materials in the VHF range”) by A. Kabalan et al., presented in relation to the twentieth Journées Nationales Microondes (a translation of which is

“National Microwave Days”) of 16 to 19 May 2017. This document refers to a material of chemical formula Ni_{0.6}Zn_{0.35}Co_{0.05}Fe_{1.98}O₄, in a form making it possible to obtain properties that are desired in terms of permeability, permittivity, and magnetic and dielectric losses.

The present invention relates to an optimized method of obtaining this material or other magneto-dielectric materials of spinet ferrite type with properties suitable for use of this material in an antenna of V/UHF type.

In particular, the invention relates to a method of obtaining a nickel zinc cobalt spinet ferrite in ceramic form comprising the following successive steps:
obtaining a precipitate of iron, nickel, zinc and cobalt hydroxides by co-precipitation;
rinsing the precipitate in order to obtain a rinsed precipitate;
drying and grinding the rinsed precipitate in order to obtain a powder;
forming into a compact by pressing the powder; and
sintering the compact.
The sintering step successively comprises:
a progressive temperature rise of 2° C. to 4° C. per minute, from an ambient temperature to reach a maximum temperature comprised between 950° C. and 1010° C.,
maintaining at the maximum temperature for forty-five minutes to three hours, and preferably between forty-five minutes and an hour and fifteen minutes, and
a progressive fall in temperature of 2° C. to 4° C. per minute to reach ambient temperature.

The method of the invention thus enables the production of a nickel zinc cobalt spinel ferrite material of ceramic form suitable in particular for the manufacture of miniature antennas. The method given enables this obtainment simply, and provides a time saving and a saving in terms of high costs compared with the methods of obtaining spinel ferrites known from the state of the art. The heat treatment applied in the sintering step makes it possible in particular to obtain a material having the desired properties.

Preferably, said maximum temperature is comprised between 985° C. and 1010° C., and is preferably equal to 995° C.

This makes it possible to eliminate the Fe²⁺ ions and thereby improve the dielectric properties of the material.

The temperature rise may advantageously be carried out at approximately 3° C. per minute, and the temperature drop may be carried out at approximately 3° C. per minute.

The step of rinsing the precipitate may comprise a succession of cleaning operations of the precipitate, each cleaning operation comprising a dilution with water at an initial temperature greater than or equal to 70° C. or heated at the time of said cleaning operation of the precipitate to a temperature greater than or equal to 70° C., followed by cooling and settling. Such rinsing when hot greatly limits the number of cleaning operations of the precipitate to carry out in the method.

Apart from the five aforesaid steps, it is possible for the method not to comprise any other step, and in particular no calcination of the powder. For the applications concerned, the Applicant has found that such calcination (also called “chamotting”), always carried out on manufacturing ceramics similar to those produced in the invention, was not only needless but was detrimental to the desired magnetic and dielectric properties.

The step of obtaining the precipitate may comprise mixing a salt solution of iron (III) chloride FeCl₃, zinc chloride ZnCl₂ and cobalt chloride CoCl₂ and a caustic soda solution.

According to alternative embodiments of the invention, the step of obtaining the precipitate may implement the reaction:

0.60NiCl₂+0.35ZnCl₂+0.05CoCl₂+1.98FeCl₃+7.94NaOH→Ni_{0.60}Zn_{0.35}Co_{0.05}Fe_{1.98}(OH)_{7.94}+7.94NaCl.

or the reaction:

0.61NiCl₂+0.35ZnCl₂+0.04CoCl₂+1.98FeCl₃+7.94NaOH→Ni_{0.61}Zn_{0.35}Co_{0.04}Fe_{1.98}(OH)_{7.94}+7.94NaCl.

At the step of rinsing the precipitate (2), successive operations of cleaning the precipitate are for example carried out at the rate of one cleaning operation per day approximately until a pH less than 8 is obtained after settling.

The step of forming a compact may comprise an operation of die-stamping, an operation of compressing a powder bed, and an operation of ejecting the compact.

The invention also relates to a method far manufacturing an antenna configured for frequencies less than one gigahertz implementing a method of obtaining a nickel zinc cobalt spinel ferrite of ceramic form according to any one of the preceding claims.

Other features of the invention will furthermore appear in the detailed examples provided below.

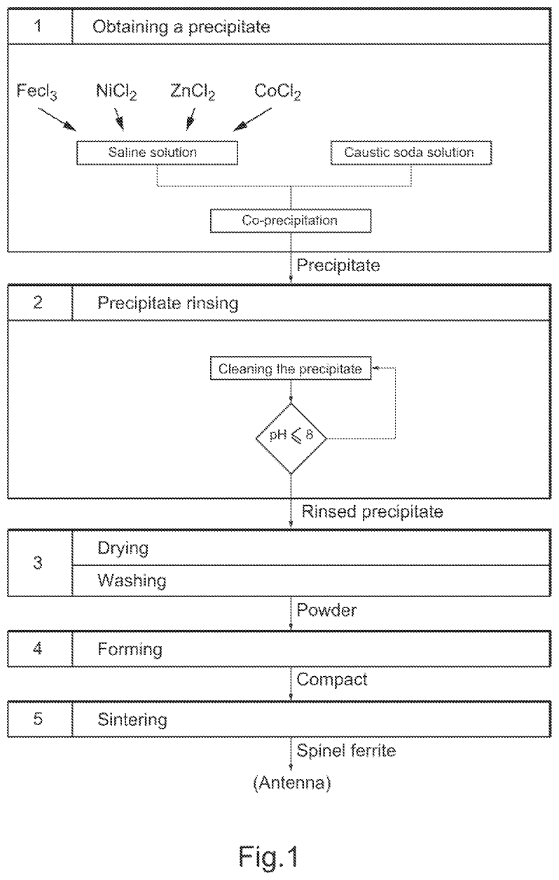

FIG. 1 (unique Figure) shows, in a flowchart, a method in accordance with an embodiment of the invention, adopted in examples No. 1, No. 2 and No. 3 detailed below.

### EXAMPLE NO. 1

The first example detailed below relates to producing the material of chemical formula Ni_{0.60}Zn_{0.35}Co_{0.05}Fe_{1.98}O₄, in a form configured for producing antennas, for example in particular for sub-gigahertz frequency ranges adapted for V/UHF antennas.

The production method comprises the following steps 1 to 5, which are detailed in the present example:

Obtaining a precipitate (1) by chemical co-precipitation;
Cleaning the precipitate (2);
Drying and grinding (3) the precipitate;
Forming (3) compacts by pressing; and
Sintering (5) the compacts.

### Obtaining a Precipitate (1) by Chemical Co-Precipitation

The ferrite type material, of chemical formula Ni_{0.6}Zn_{0.35}Co_{0.05}Fe_{1.98}O₄, is obtained in the farm of a precipitate in this first step by co-precipitation of chloride salts in a solution of caustic soda.

The chloride salts used are the following:

iron (III) chloride hexahydrate, of chemical formula FeCl₃, 6H₂O; of molar mass 270.30 g.mol⁻¹; this product being designated below in this first example by the term “FeCl₃”.
nikel chloride hexahydrate, of chemical formula NiCl₂, 6H₂O: of molar mass 237.71 g.mol⁻¹; designated below in this first example by the term “NiCl₂”.
zinc chloride ZnCl₂; of molar mass 136.30 g.mol⁻¹; designated below in this first example by the term “ZnCl₂”; and
cobalt chloride hexahydrate, of chemical formula CoCl₂, 6H₂O; of molar mass 237.93 g.mol⁻¹; designated below in this first example by the term “CoCl₂”.

According to the composition desired for the ferrite material, the various chloride salts are weighed so as to have a total mass of 20 grams of chloride salts, while complying with the stoichiometry of the metal elements of the final material.

The weighing operations are carried out in a METTLER TOLEDO balance, model XS203S using a glass pan.

The preparation of a ferrite material in accordance with the present first example from 20 grams of chloride salts requires the following weighing operations to be carried out:

### 14.515 g of FeCl₃,

### 3.868 g of NiCl₂,

### 1.294 g of ZnCl₂, and

### 0.323 g of CoCl₂.

After each weighing operation, the content of the glass pan is poured into a 500 mL beaker containing 100 mL of deionized water. The glass pan is rinsed over that beaker using a wash bottle containing 150 mL of deionized water. Only an arbitrary part of the content of the wash bottle is used for each rinsing operation. The pan is considered as rinsed when it is no longer possible to perceive a chloride salt crystal with the naked eye. The pan is dried using a sheet of absorbent paper, then replaced in the balance for the next weighing operation. When all the chloride salts have been weighed and poured into the beaker, and the pan has been rinsed, the remaining deionized water contained in the wash bottle is entirely poured into the beaker which then contains 20 grams of salts and 250 mL of deionized water. Manual stirring using an iron spatula makes it possible to render the salt solution uniform and to accelerate the dissolution of the chloride salts. The complete dissolution of the chloride salts in the deionized water is observed after 5 minutes.

This solution is designated below in this first example by the expression “salt solution”.

A caustic soda solution is prepared from:

1.6 liter of deionized water contained in an Erlenmeyer flask having a capacity of 3 liters, and within which is a magnetic stir bar;
26.00 grams of caustic soda pellets of chemical formula NaOH and molar mass 39.997 g.mol⁻¹, weighed in the METTLER TOLEDO balance, model XS203S using a glass pan; and
a wash bottle containing 0.2 liter deionized water.

The Erlenmeyer flask containing 1.6 liter water and the magnetic stir bar, is place on a Fisher Scientific Isotemp magnetic hot plate with which it is possible to set a heating temperature as well as the rotational speed of the magnetic stir bar in order to keep a liquid medium stirred.

For the synthesis of the material which is the subject of the present first example, the hot plate is set to a heating temperature of 430° C. with a rotational speed of the magnetic stir bar of 300 revolutions per minute.

The weighed caustic soda pellets are added to the Erlenmeyer flask, the glass pan having contained the caustic soda pellets is rinsed using the entire content of the wash bottle of deionized water; this rinsing water being entirely poured into the Erlenmeyer flask. The caustic soda pellets are then dissolved in 1.8 L deionized water, this solution, designated below in the present example by the expression “basic solution” is made to boil under magnetic stirring.

When the basic solution starts to boil, the heating temperature of the hot plate is set to 330° C. and the rotational speed of the magnetic stir bar is maintained at 300 revolutions per minute.

The salt solution enabling the synthesis of the ferrite material of the present first example is poured into the basic solution.

The chloride salts react with the caustic soda leading to the formation of a brown precipitate of chemical formula Ni_{0.60}Zn_{0.35}Co_{0.05}Fe_{1.98}(OH)_{7.94} and sodium chloride NaCl according to the following reaction:

0.60NiCl₂+0.35ZnCl₂+0.05CoCl₂+1.98FeCl₃7.94NaOH→7Ni_{0.60}Zn_{0.35}Co_{0.05}Fe_{1.98}(OH)_{7.94}+7.94NaCl

As the basic solution contains an excess amount of caustic soda relative to the amount required to react with the chloride salts, the Erlenmeyer flask contains, after this reaction:

a brown precipitate from which the ferrite material will be synthesized; and
the remainder of the basic solution that did not participate in the reaction and the dissolved sodium chloride NaCl (this combination being designated below in the present example by the expression “excess basic solution”).

The salt and basic solutions are left to react for 45 minutes while being stirred and boiled. After the 45 minutes, the magnetic stirring and the heating are stopped and the Erlenmeyer flask is removed from the hot plate. The magnetic stir bar is recovered using a magnet and is rinsed with deionized water. The content of the Erlenmeyer flask, that is to say the brown precipitate and the excess basic solution, is poured into a beaker having a capacity of 3 liters. The inside of the Erlenmeyer flask is rinsed with a wash bottle of distilled water and that rinsing water is poured into the beaker containing the precipitate and the excess basic solution. The content of the beaker is left to cool to ambient temperature and until the precipitate has settled to the bottom of the beaker and the excess basic solution is clear. When these conditions are satisfied, the step of rinsing or cleaning the precipitate is proceeded to.

### Rinsing the Precipitate (2)

As much a possible of the excess basic solution is evacuated to a suitable container. The evacuation is interrupted when the precipitate is on the point of being evacuated too. There then remains in the beaker:

the brown precipitate, and
a remainder of excess basic solution which has not been evacuated so as to avoid any loss of brown precipitate.

This operation makes it possible to eliminate most of the excess caustic soda and the sodium chloride NaCl formed during the chemical reaction.

Another Erlenmeyer flask having a capacity of 3 liters is filled with 2 liters of deionized water.

This Erlenmeyer flask is placed on the hot plate. The hot plate is set to a heating temperature of 430° in order to make the deionized water contained in the Erlenmeyer flask boil. After 30 minutes, the deionized water starts to boil, and the content of the Erlenmeyer flask is then poured into the beaker which then contains:

the brown precipitate, and
the remainder of the basic solution which has now been diluted due to the addition of deionized water (this combination being designated below in the present first example by the term “liquid”).

This operation is designated by the expression “cleaning the preparation” and is carried out once per day.

After the operation of cleaning the preparation, the content of the beaker is left to cool to ambient temperature until the precipitate has settled to the bottom of the beaker and the liquid is clear.

The pH of the liquid is measured using a pH-meter. If the measured pH is greater than 8, a maximum of liquid is evacuated to a suitable container while avoiding evacuating the precipitate and a new operation of cleaning the preparation is then carried out.

This sequence is repeated until a pH less than 8 is obtained. This condition is generally attained after 5 operations of cleaning the preparation (i.e. after 5 days).

The number of operations of cleaning the preparation required may vary according to the amount of liquid that it was possible to evacuate during each operation of cleaning the preparation.

When the liquid has a pH less than 8, a maximum of liquid is evacuated into a suitable container while avoiding evacuating the precipitate.

It is then possible to proceed to the step of drying and grinding the precipitate.

### Drying and Grinding (3) the Precipitate

The brown precipitate and the liquid remainder will be designated below for the present example by the term “preparation”.

The preparation is decanted into a beaker of 250 mL. The 3 liter beaker which contained the preparation is rinsed using a wash bottle of distilled water, the rinsing water is poured into the 250 mL beaker containing the preparation, then the beaker is placed in an oven at 55° C. for 72 hours.

After these 72 hours of drying or desiccation, the liquid has entirely evaporated, and there only remains the brown precipitate which is in the form of a dry, dark gray mixture. This mixture is recovered then ground to powder form using a pestle and mortar, which form is designated below for the present example by term “powder”. This powder may then be placed in a labeled plastic bottle closed with a plug and is stored in a moisture-controlled cabinet.

It is notable that contrary to the methods known in the state of the art, no centrifuge is employed to separate the particles formed by co-precipitation of the liquid. This is because the Applicant has found that despite the care that could be taken with such centrifugation, there always remained a fraction of the smallest particles of the precipitate on the sides of the test tubes used in the centrifugation. However, these particles of small average diameter play a major role in the later heat treatments of the method (i.e. during the sintering), on account of their high reactivity which is due to their relatively high surface area/volume ratio. The drying in an oven (typically at a temperature of approximately 50° C. to 55° C.) thus makes it possible to retrieve practically the entirety of the co-precipitation product, especially the finest particles.

### Forming (4) Compacts by Pressing

The powder is used to produce samples referred to as “compacts”, by a method referred to as “pressing”. The pressing method consists in the sequence of the three following operations which are detailed below;

die-stamping operation,
operation of compressing the powder bed, and
operation of ejecting the compact.

The die-stamping operation consists of:

placing an amount of powder, designated by the term “powder bed” in the present example, into a cylindrical hollow steel die, designated by the term “die”, of which the lower end is blocked by a cylindrical punch, designated by the term “lower punch” in the present example, and which is has been inserted in advance such that the powder cannot fall out of the die; and
inserting another cylindrical punch, designated by the expression “upper punch”, into the present example, in the upper end of the die and placing it in contact with the powder bed.

The assembly comprises the die, the powder bed, the lower punch and the upper punch is designated by the expression “forming die” in the present example.

The forming die is then placed into a SODEMI RD 60 E uniaxial press with which the operation of compressing the powder bed is carried out.

The operation of compressing the powder bed comprises

hydraulically raising a plate on which rests the forming die: the upper punch then enters into contact with a fixed cylindrical frame and the powder bed is then compressed from bottom to top; the raising of the plate is performed in one minute until a compression stress of 120 MPa applied to the powder bed is reached.
maintaining the compression stress for one minute; and
progressively reducing the compression stress, at the end of the maintaining duration, by lowering the plate on which rests the forming die in one minute until total cancelling of the compression stress.

The result of compressing the powder bed is obtaining a compact.

After release of the compression, it is possible to perform the operation of ejecting the compact which consists of:

turning over the forming die; and
taking the compact out of the die by pushing the lower punch downwardly using the press.

The compact is recovered. Its mass and dimensions are measured.

The operations of die-stamping, compressing the powder bed and ejecting are repeated in order to obtain the desired number of compacts.

### Sintering (5) the Compacts

The last step for obtaining the material that is the subject of the first example consists of submitting the compacts to a heat treatment which will make it possible to consolidate the materials and to confer their magneto-dielectric properties.

The compacts are put into an alumina crucible which is then placed in a PYROX tubular oven with which the heat treatment can be programmed.

The following heat treatment is programmed and applied:

raising temperature by 3° C. per minute to reach the temperature of 950° C.;
holding the temperature of 950° C. for 3 hours;
lowering temperature by 3° C. per minute to reach ambient temperature.

This heat treatment is designated in the present example by the expression “sintering at 950° C”.

After the sintering at 950° C., the compacts are then designated by the expression “sintered compacts”.

The sintered compacts of the material which is the subject of the present first example are then recovered.

At ambient temperature they have the following magneto-dielectric properties in the frequency range 118-174 MHz:

a real permeability value μ′ comprised between 15.6 and 16.6;
a real permittivity value ε′ comprised between 13.6 and 12.1; and
a magnetic loss tangent defined by the ratio between the imaginary permeability value μ″ and the value of the real permeability μ′ of the material that is the subject of the present first example which is comprised between 0.034 and 0.044;
a dielectric loss tangent defined by the ratio between the imaginary permittivity value ε″ and the value of the real permittivity ε′ of the material that is the subject of the present first example which is comprised between 0.064 and 0.032.

Thus, the material that is the subject of the of the present first example meets the criteria required for producing miniature fixed antennas in the frequency range 118-172 MHz.

### EXAMPLE NO. 2

The second example detailed below relates to producing the material of chemical formula Ni_{0.61}Zn_{0.35}Co_{0.04}Fe_{1.98}O₄, in a form configured for producing antennas, for example in particular for sub-gigahertz frequency ranges adapted for V/UHF antennas.

The production method comprises the following steps 1 to 5, which are detailed in the present example:

Obtaining a precipitate (1) by chemical co-precipitation;
Rinsing the precipitate (2);
Drying and grinding (3) the precipitate;
Forming (4) compacts by pressing; and
Sintering (5) the compacts.

### Obtaining a Precipitate (1) by Chemical Co-Precipitation

The ferrite type material, of chemical formula Ni_{0.6}Zn_{0.35}Co_{0.04}Fe_{1.98}O₄, is obtained in the form of a precipitate in this first step by co-precipitation of chloride salts in a solution of caustic soda.

The chloride salts used are the same as in the first example.

According to the composition desired for the ferrite material, as in the first example, the various chloride salts are weighed so as to have a total mass of 20 grams of chloride salts, while complying with the stoichiometry of the metal elements of the final material.

The weighing operations are carried out in a METTLER TOLEDO balance, model XS203S using a glass pan.

The preparation of a ferrite material in accordance with the present second example from 20 grams of chloride salts requires the following weighing operations to be carried out:

### 14.515 g of FeCl₃,

### 3.933 g of NiCl₂,

### 1.294 g of ZnCl₂, and

### 0.258 g of CoCl₂.

Each of the salts is weighed separately, in a glass pan, according to the protocol defined in the first example.

A solution is obtained designated by the expression “salt solution”.

A solution of caustic soda is prepared according to the protocol detailed for the first example, resulting in obtaining a solution referred to as “basic solution”,

The salt solution enabling the synthesis of the ferrite material of the present second example is poured into the basic solution.

The chloride salts react with the caustic soda leading to the formation of a brown precipitate of chemical formula Ni_{0.61}Zn_{0.35}Co_{0.04}Fe_{1.98}(OH)_{7.94} and sodium chloride NaCl according to the following reaction:

0.61NiCl₂+0.35ZnCl₂+0.04CoCl₂+1.98FeCl₃+7.94NaOH→7Ni_{0.61}Zn_{0.35}Co_{0.04}Fe_{1.98}(OH)_{7.94}+7.94NaCl

As the basic solution contains an excess amount of caustic soda relative to the amount required to react with the chloride salts, the Erlenmeyer flask contains, after this reaction:

a brown precipitate from which the ferrite material will be synthesized; and
the remainder of the basic solution that did not participate in the reaction and the dissolved sodium chloride NaCl (this combination being designated below in the present example by the expression “excess basic solution”).

Just as for the first example, the salt and basic solutions are left to react for 45 minutes while being stirred and boiled. After the 45 minutes, the magnetic stirring and the heating are stopped and the Erlenmeyer flask is removed from the hot plate. The magnetic stir bar is recovered using a magnet and is rinsed with deionized water. The content of the Erlenmeyer flask, that is to say the brown precipitate and the excess basic solution, is poured into a beaker having a capacity of 3 liters. The inside of the Erlenmeyer flask is rinsed with a wash bottle of distilled water and that rinsing water is poured into the beaker containing the precipitate and the excess basic solution. The content of the beaker is left to cool to ambient temperature and until the precipitate has settled to the bottom of the beaker and the excess basic solution is clear. When these conditions are satisfied, the step of rinsing or cleaning the precipitate is proceeded to.

### Rinsing the Precipitate (2)

Successive operations of cleaning the precipitate are carried out according to the protocol and the criteria defined in the first example.

It is then possible to proceed to the step of drying and grinding the precipitate.

### Drying and Grinding (3) the Precipitate

This step is identical to that described r the first example.

### Forming (4) Compacts by Pressing

This step is identical to that described for the first example.

In particular, the operations of die-stamping, compressing a powder bed and ejecting the compact are identical to those described for the first example, They are repeated in order to obtain the desired number of compacts.

### Sintering (5) the Compacts

This step and in particular the “sintering at 950°” which is implemented therein is identical to that described for the first example.

The sintered compacts of the material which is the subject of the present second example are then recovered.

At ambient temperature they have the following magneto-dielectric properties in the frequency range 118-174 MHz:

a real permeability value μ′ comprised between 19.2 and 21;
a real permittivity value ε′ comprised between 13.2 and 13.5;
a magnetic loss tangent defined by the ratio between the imaginary permeability value μ″ and the value of the real permeability μ′ of the material that is the subject of the present second example which is comprised between 0.02 and 0.03; and
a dielectric loss tangent defined by the ratio between the imaginary permittivity value ε″ and the value of the real permittivity ε′ of the material that is the subject of the present second example of 0.01.

Thus, the material that is the subject of the of the present second example meets the criteria required for producing miniature fixed antennas in the frequency range 118-172 MHz.

### EXAMPLE NO. 3

The second example detailed below relates to producing the material of chemical formula Ni_{0.61}Zn_{0.35}Co_{0.04}Fe_{1.98}O₄, that is to say of the same chemical formula as the material in example No. 2, in a form configured for producing antennas, for example in particular for sub-gigahertz frequency ranges adapted for V/UHF antennas

The production method comprises the same steps 1 to 5 as the preceding examples. As regards the steps for obtaining a precipitate (1) by chemical co-precipitation: rinsing the precipitate (2), drying and grinding (3) the precipitate, and forming (4) compacts by pressing, the description made above with reference to Example No. 2 applies to Example No. 3.

Different parameters are nevertheless applied in the sintering step (5) described below.

The last step for obtaining the material that is the subject of the third example, referred to as sintering (5) the compacts, thus comprises steps of subjecting the compacts to a heat treatment in conditions similar to Examples No. 1 and No. 2 described above. In particular, the following heat treatment is programmed and applied:

raising temperature by 3° C. per minute to reach the temperature of 995° C.;
holding the temperature of 995° C. for 1 hour;
lowering temperature by 3° C. per minute to reach ambient temperature.

This heat treatment is designated in the present example by the expression “sintering at 995° C.”.

After the sintering at 995° C., the compacts are then designated by the expression “sintered compacts”.

The sintered compacts of the material which is the subject of he present third example are then recovered.

At ambient temperature they have the following magneto-dielectric properties in the frequency range 118-174 MHz:

a real permeability value μ′ comprised between 15.6 and 16.6;
a real permittivity value ε′ comprised between 12.1 and 12.5 and
a magnetic loss tangent defined by the ratio between the imaginary permeability value μ″ and the value of the real permeability μ′ of the material that is the subject of the present third example which is comprised between 0.034 and 0.044;
a dielectric loss tangent defined by the ratio between the imaginary permittivity value ε″ and the value of the real permittivity ε′ of the material that is the subject of the present third example which is comprised between 0.030 and 0.032.

Thus, the material that is the subject of the of the present third example meets the criteria required for producing miniature fixed antennas in the frequency range 118-172 MHz.

The materials thus obtained are semi-dense microporous ceramics the porosity of which is mastered, constituted by nanometric particles of spinel ferrites.

As regards the composition of the ferrites obtained, according to certain embodiments, the present invention provides ferrites with dielectric properties that are substantially improved compared with the closest ferrites known in the state of the art. In particular, the scientific paper from 2009 entitled “Influential parameters on electromagnetic properties of nickel-zinc ferrites for antenna miniaturization” by Messrs. Souriou and Mattei concerns the synthesis of a ferrite of nominal composition Ni_{0.6}Zn_{0.3}Co_{0.2}Fe₂O₄.

The composition of the materials disclosed above is substantially different. For example, under the present invention a spinel ferrite is disclosed of nominal composition Ni_{0.61}Zn_{0.4}Co_{0.035}Fe_{1.98}O₄. The most notable difference between this composition and that known in the prior art resides in the proportion of Iron. The sub-stoichiometric composition of Iron given as a matter of fact makes it possible to substantially reduce dielectric losses. This is not immediately visible if the measured values of the permittivities of the two aforementioned materials are compared, since the material described in the prior art has a high porosity, whereas the material provided in the present invention is very dense. However, through the inter-comparison of the permittivities of stoichiometric materials and non-stoichiometric materials of same density, the applicant has established that the sub-stoichiometric compositions have a dielectric loss tangent defined by the ratio between the value of the imaginary permittivity ε″ and the value of the real permittivity ε′ of the material that is the subject of the present third example that is reduced relative to that of the stoichiometric materials, and in particular the composition mentioned above has a dielectric loss tangent that is reduced by 30% relative to that of the stoichiometric materials.

In particular, the examples detailed above enable the production of spinel ferrite materials that are magneto-dielectric (that is to say having both a magnetic susceptibility and a dielectric permittivity that are not zero) in the form of ceramics that are partially dense (porosity 15%-20%) and constituted by sufficiently small grains (the average size of the crystallites is 40 nm approximately). This small size is in particular obtained by the heat treatment not exceeding 1010° C. The desired properties are also obtained by virtue of the rising and falling temperature slopes adopted. A rising temperature slope should be adopted that is suitable for providing the required provision of heat energy, but that provision must not be too fast so as not to create microporosity in the material. Similarly, during the temperature drop the atoms become arranged within the crystal lattice, such that a falling temperature slope should be adopted that is adapted for the desired properties. Whether when rising or falling, a slope of approximately 3° C. per minute appears optimal, but more generally slopes comprised between 2° C. and 4° C. per minute (it being possible for this value to be fixed or variable between these bounds) are acceptable. A maximum temperature of the order of 950° C. is suitable, but a temperature of 985° C. or more is preferred as it avoids the presence of Fe²⁺ ions which enables an insulating material to be obtained.

The small size of the grains enables the possible contribution of magnetic domain walls (i.e. the contribution of the transition zones between two different magnetization domains) to the permeability of magnetic domain walls to be strongly limited. It is as a matter of fact this contribution which is at the origin of most of the magnetic losses when the size of the grains does not exceed a critical value.

The temperature stability of the desired properties of such materials has been verified. Thus, these materials are temperature qualified (between −50° C. and +85° C., that is to say a temperature range suitable for qualification for aeronautical applications) as regards maintaining properties required for constituting an antenna, in particular in the frequency range 118-172 MHz.

Furthermore, some of the materials developed are compatible with the LTCC integration technology, LTCC being the acronym for “Low Temperature Co-fired Ceramic”.

The manufacturing method implementation thus makes it possible to obtain materials which, employed in the constitution of a V/UHF antenna, enable a size reduction for the antenna which may be as much as 60% (compared with an antenna constituted according to the state of the art) while preserving the performance required for said antenna.

A miniature antenna so constituted is of great interest in airborne applications.

More generally, the materials obtained by a method according to the invention are particularly advantageous when the frequencies addressed are less than one Gigahertz.

The electromagnetic losses of these materials are kept to levels that are notably low for a ceramic type medium, over this frequency band, and in particular in the band concerned which is more particularly comprised between 118 MHz and 172 MHz.

It has furthermore been found that the use of hot water in the steps of cleaning the precipitate enable accelerated settling and lastly more effective rinsing making it possible to limit the number of cleaning operations of the precipitate (compared with the co-precipitation methods known in the state of the art). For example, to obtain the pH criterion lower than 8, the number of cleaning operations is divided by 2 on average (from 10 cleaning operations to 5) i.e. a time saving of 50% for this step.

By hot water, is meant water at the temperature obtained according to the protocol described at the step of cleaning the precipitate in the examples detailed above, or more generally water at approximately 70°, or more than 70° C.

Contrary to the known methods, it is not necessary in a method in accordance with the invention to perform a step of calcination directed to eliminating the binders and prior to forming and sintering. It is to be recalled that the calcination carried out in the methods according to the state of the art comprise a temperature rise at a rate of 3 K per minute, followed by a plateau of 3 h at a temperature comprised between 600° C. and 800° C., followed by progressive cooling at 3K per minute of the powders arising from the co-precipitation. It has been discovered that performing a calcination step does not give better characteristics to the material arising from a method in accordance with the invention, for the production of spinel ferrite having the desired properties.

Furthermore, according to the state of the art the calcination must be followed by manual grinding of the powders prior to being able to proceed with the forming and the sintering. This grinding step after calcination is of no relevance in the invention, in the absence of calcination. The saving in production time is great, of the order of several hours, and the energy saving compared with the known methods is also high.

The absence of calcination in the preferred embodiments of the invention is a very unusual aspect relative to the methods generally used in the field of ceramics.

For example, in the scientific paper of 2009 mentioned above, calcination was always carried out.

The applicant has nevertheless discovered that, in order to obtain a material configured for forming antennas for weaker frequencies that at the period of that article (typically frequencies less than 180 MHz as compared with frequencies ranging up to 850 MHz with the materials presented in the paper from 2009), eliminating the calcination step of the method of obtaining spinel ferrite provided great advantages. As a matter of fact, the applicant has found that it is during this calcination (chamotting) step that the reactivity of the particles is exploited, in the state of the art, with the aim of initiating exchanges of matter between neighboring particles. This is especially the case for the small particles, which are very reactive due to their surface area/volume ratio, and which play a triggering role in these exchanges of matter. By eliminating this calcination step the enlargement of the particles during the sintering is limited, which limits the appearance of magnetic domain walls, and therefore limits the associated magnetic losses.

In particular, the material obtained has a low porosity for sintering temperatures less than 1000° C. As a corollary, this provides another advantage, which is a consequence of the quite low value of this sintering temperature, that is to say that the evaporation of the Zn²⁺ ions is avoided (it being possible for this to occur starting from 1050° C.).

The materials employed in a method according to the invention exclude, at least for a large proportion of the embodiments envisioned, rare earth metals, lithium, etc. and are classified among those having a relatively low environmental footprint.

Ultimately, the materials obtained with the method in accordance with the invention are able to provide the following features and advantages:

low electromagnetic (magnetic and dielectric) losses in the frequency band 118 MHz-174 MHz. and in the temperature range −50° C.<T<85° C.;
a permeability 3 to 5 times higher than that described in the literature for comparable materials,
low costs both for obtaining materials and for their employment;
ease of implementation, in that a minimum of technological equipment is required, and no specific equipment;
a low environmental footprint in particular as regards the manufacturing process.

1. Method of obtaining a nickel zinc cobalt spinel ferrite in ceramic form comprising, successively, the following;
obtaining a precipitate (1) of iron, nickel, zinc and cobalt hydroxides by co-precipitation;
rinsing the precipitate (2) in order to obtain a rinsed precipitate;
drying and grinding (3) the rinsed precipitate in order to obtain a powder;
forming into a compact (4) by pressing the powder; and
sintering the compact,
wherein the sintering successively comprises:
a progressive temperature rise of 2° C. to 4° C. per minute, from an ambient temperature to reach a maximum temperature comprised between 950° C. and 1010° C.,
maintaining at the maximum temperature for forty-five minutes to three hours, and preferably between forty-five minutes and an hour and fifteen minutes, and
a progressive fall in temperature of 2° C. to 4° C. per minute to reach ambient temperature.

2. Method according to claim 1, wherein:
said maximum temperature is comprised between 985° C. and 1010° C., and is preferably equal to 995° C.

3. Method according to claim 1, wherein:
the temperature rise is carried out at approximately 3° C. per minute, and the temperature drop is carried out at approximately 3° C. per minute.

4. Method according to claim 1, wherein:
the rinsing the precipitate (2) comprises a succession of cleaning operations of the precipitate, each cleaning operation comprising a dilution with water at an initial temperature greater than or equal to 70° C. or heated at the time of said cleaning operation of the precipitate to a temperature greater than or equal to 70° C., followed by cooling and settling.

5. Method according to claim 1, wherein:
the method does not comprise calcination of the powder.

6. Method according to claim 1, wherein:
the obtaining the precipitate (1) comprises mixing a salt solution of Iron (III) chloride FeCl₃, zinc chloride ZnCl₂ and cobalt chloride CoCl₂ and a caustic soda solution.

7. Method according to claim 6, wherein:
the obtaining the precipitate (1) implements the reaction:
0.60NiCl₂+0.35ZnCl₂+0.05CoCl₂+1.98FeCl₃+7.94NaOH→7Ni_{0.60}Zn_{0.35}Co_{0.05}Fe_{1.98}(OH)_{7.94}+7.94NaCl,
or the reaction:
0.61NiCl₂+0.35ZnCl₂+0.04CoCl₂+1.98FeCl₃+7.94NaOH→7Ni_{0.61}Zn_{0.35}Co_{0.04}Fe_{1.98}(OH)_{7.94}+7.94NaCl.

8. Method according to claim 6, wherein:
at the rinsing the precipitate (2), successive operations of cleaning the precipitate are carried out at the rate of one cleaning operation per day until a pH less than 8 is obtained after settling.

9. Method according to claim 1, wherein:
the forming (4) a compact comprises an operation of die-stamping, an operation of compressing a powder bed, and an operation of ejecting the compact.

10. Method for manufacturing an antenna configured for frequencies less than one gigahertz implementing a method of obtaining a nickel zinc cobalt spinel ferrite of ceramic form according to claim 1.
